(19) United States
(12) Patent Application Publication
(10) Pub. No.: US 2016/0078462 A1
(43) Pub. Date: Mar. 17, 2016

(54) KIOSK MARKETING PROMOTION SYSTEM AND METHOD

(71) Applicant: GIFT CARD IMPRESSIONS, LLC, Kansas City, MO (US)

(72) Inventors: Brett R. Glass, Kansas City, MO (US); Nicole E. Glass, Kansas City, MO (US)

(21) Appl. No.: 14/947,936

(22) Filed: Nov. 20, 2015

Related U.S. Application Data
(63) Continuation-in-part of application No. 13/946,749, filed on Jul. 19, 2013.
Application No. 13/946,749 is a continuation-in-part of application No. 14/828,948, filed on Aug. 18, 2015.
(60) Provisional application No. 62/083,014, filed on Nov. 21, 2014.
(60) Provisional application No. 61/818,795, filed on May 2, 2013.
(60) Provisional application No. 62/038,683, filed on Aug. 18, 2014.

(51) Int. Cl. G06Q 30/02; G06Q 20/18

(52) U.S. Cl. CPC G06Q 30/0212; G06Q 20/18

(57) ABSTRACT

A kiosk marketing promotion system includes a retail kiosk to hold and display one or more stored value cards, and a kiosk computing device to be housed and supported by the retail kiosk. The computing device has a display screen for playing an interactive marketing promotion video on the display screen to play advertising content associated with the stored value cards displayed by the retail kiosk. The interactive marketing promotion video also receives, from the consumer, personal information associated with the consumer, and when the personal information is received, determine whether the consumer wins a prize according to a specified probability, the prize comprising at least one of the stored value cards displayed by the retail kiosk.

### RELATED APPLICATIONS

This application takes priority to U.S. Provisional Patent Application Ser. No. 62/083,014, filed Nov. 21, 2014, and entitled “Kiosk Marketing Promotion System and Method,” U.S. patent application Ser. No. 13/946,749, filed Jul. 19, 2013, and entitled “Stored Value Card Display Advertising System and Method, and U.S. patent application Ser. No. 14/828,948, filed Aug. 18, 2015, and entitled “Targeted Advertising System and Method For a Retail Kiosk.” The contents of 62/083,014, Ser. Nos. 13/946,749, and 14/828,948 are incorporated herein by reference in their entirety.

### FIELD OF INVENTION

The present invention generally relates to retail devices, and more particularly, to a kiosk marketing promotion system and method.

### BACKGROUND

Stored value cards, such as pre-paid phone services, general purpose, reloadable credit/debit cards, including open loop and closed loop prepaid cards, and the like, have become popular gifts. Stored value cards typically comprise a certain cash equivalent value that is encoded upon a magnetic strip applied to the surface of the card. This stored value may be determined by the vendor prior to packaging and display for sale or is selected at the point of sale by the purchaser and loaded by the cashier using a magnetic card reader/writer. Holders for stored value cards have been used both to simply store stored value cards and to provide a surface for decorative indicia and graphics, as well as personalized or preprinted text.

### SUMMARY

According to one embodiment, a kiosk marketing promotion system includes a retail kiosk to hold and display one or more stored value cards, and a kiosk computing device to be housed and supported by the retail kiosk. The computing device has a display screen for playing an interactive marketing promotion video on the display screen to play advertising content associated with the stored value cards displayed by the retail kiosk. The interactive marketing promotion video also receives, from the consumer, personal information associated with the consumer, and when the personal information is received, determine whether the consumer wins a prize according to a specified probability, the prize comprising at least one of the stored value cards displayed by the retail kiosk.

### BRIEF DESCRIPTION OF THE DRAWINGS

FIG. 1A is a block diagram of a computing system that includes a kiosk marketing promotion system.

FIG. 1B depicts an exemplary embodiment of a computing device according to one aspect of the kiosk marketing promotion system.

FIG. 1C depicts an exemplary embodiment of a data source according to an aspect of the kiosk marketing promotion system.

FIG. 2 is a block diagram of an example kiosk management server according to an aspect of the kiosk marketing promotion system.

FIG. 3 is a flowchart depicting an example process for managing an account of a consumer item displayed on a kiosk according to an aspect of the kiosk marketing promotion system.

FIG. 4 illustrates an example of a splash screen according to an aspect of the kiosk marketing promotion system.

FIGS. 5A and 5B illustrate an example countdown timer screen display of a user interface according to an aspect of the kiosk marketing promotion system.

FIG. 6 illustrates an example of a consumer registration screen of a user interface according to an aspect of the kiosk marketing promotion system.

FIG. 7A illustrates an example of a winner screen of a user interface according to an aspect of the kiosk marketing promotion system.

FIG. 7B illustrates an example of a loser screen of a user interface according to an aspect of the kiosk marketing promotion system.

FIG. 8 illustrates a block diagram of an example computer device for use with the example embodiments.

### DETAILED DESCRIPTION

Embodiments of the present disclosure provide a kiosk marketing promotion system that enhances the appeal for stored value cards displayed for sale in a retail environment. The enhanced appeal is provided by a computing device configured in a kiosk that plays interactive advertising content in the form of a prize giveaway scheme in which consumers may register their personal information to determine whether they have won a prize, which may be for example, a stored value card displayed on the kiosk. The advertising content may also include a countdown timer that entices the consumer to interact with the system within a specified time frame. The advertising content may also display names of previous winners of the prize giveaway scheme to promote involvement by each consumer.

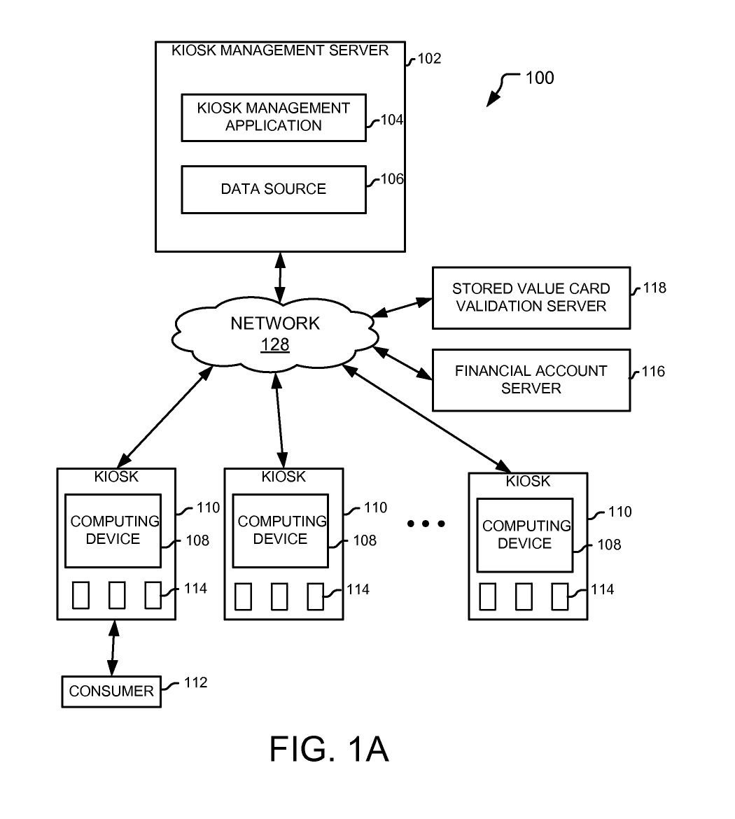

FIGS. 1A through 1C depict an example kiosk marketing promotion system 100 according to aspects of the disclosure. The system 100 includes a kiosk management server 102 or other computing device or system that includes a kiosk management application 104 and a data source 106. As will be described in detail below, the kiosk management application 104 distributes interactive marketing promotion content (e.g., audio and/or video content) to a computing device 108 configured in each of one or more retail kiosks 110. Each computing device 108 plays the content such that, when a consumer 112 registers their personal information with the system 100, the system determines whether the consumer wins a prize, which may be for example, a stored value card displayed by the system.

The server 102 and the computing device 108 may communicate with each other in any suitable manner to provide the marketing content for the consumer's consumption. For example, the computing device 108 may function as a thin client such that the content is generated by, and interactively controlled by the kiosk management application 104. That is, the kiosk management application 104 calculates the odds for each interactive session with a consumer, and determines whether each consumer wins a prize. For another example, the computing device 108 may function as a thick client in which the interactive content is downloaded at ongoing intervals to each computing device 108 such that the computing device 108 calculates the odds for each interactive session with a consumer, and determines whether each consumer wins a prize. In this case, the kiosk management application 104 may determine which interactive content to be downloaded and how often it is to be downloaded for each retail kiosk 110.

The kiosk 110 may be any suitable type that may be used in a retail environment, such as a store where stored value cards 114 are sold. For example, the retail kiosk 110 may include a counter-top housing with a bottom end to be mounted on a counter-top, a floor stand housing with a bottom end to be mounted on a floor, or a wall-mount housing configured to be mounted on a wall. Examples of such retail kiosks are described in U.S. patent application Ser. No. 13/946,679, entitled “Stored Value Card Kiosk System and Method,” which is hereby incorporated by reference in its entirety.

In one embodiment, the system 100 also conducts a transaction with the consumer 112 for purchasing one or more stored value cards 114 displayed on the retail kiosk 110. That is, the management application 104 receives stored value card activation information from the computing device 108 of the kiosk 110 and facilitates activation of a selected stored value card 114 via a monetary transaction consummated with a financial account server 116 of the user and/or a stored value card validation server 118 to pay for the activated stored value card 114. The stored value card may be physical stored value card or may be a digital stored value card (e-stored value card) that may be transmitted to a computing device (e.g., a smart phone) of the consumer 112 via a messaging service, such as e-mail, a short message service (SMS), or a multimedia message service (MMS), or other suitable digital communication medium. The server 102 may also communicate with a website of a retailer, such as a mail order retailer, or processing center of a retailer or other entity that processes incoming orders for products and fulfills these orders by managing shipment of the ordered product to the purchaser or other recipient and payment for the ordered product from the purchaser.

The stored value card validation server 118 and the financial account server 116 have one or more processors and executable instructions stored in volatile and/or non-volatile memory for performing the actions and/or steps described herein.

In one embodiment, the server 102 communicates with a financial account server 116 that is associated with a financial account of the user to provide payment for the activated stored value card by the user. The server 102 may also communicate with the computing device 108 to receive cash payment via a cash processing unit configured on the retail kiosk 110. The financial account may be any type, such as a credit card account, a debit card account, or a PAYPAL™ account. Prior to activation of the stored value card, the server 102 facilitates a financial transaction between the stored value card validation server 118 and the financial account server 116 associated with the user to provide payment for the stored value card. The stored value card validation server 102 and the financial account server 102 have one or more processors and executable instructions stored in volatile and/or non-volatile memory for performing the actions and/or steps described herein.

The kiosk 110 is generally placed in any suitable location for receiving and processing account information with a consumer 112. For example, the kiosk 110 configured to process account information associated with debit cards may be placed in locations where debit cards are typically sold or managed, such as bank lobbies, or retail stores where the debit cards are typically used. As another example, a kiosk 110 configured to process account information associated with communication services, such as those provided by prepaid communication devices, may be placed in locations where communication services are serviced and/or sold, such as electronics stores, retail stores, and the like.

The computing device 108 of the kiosk 110 may interact with the consumer 112 for entry of information as well as providing information associated with managing the account to the consumer 112. The kiosk marketing promotion system 100 facilitates payment processing using monetary processing units, such as a card reader 112 and/or a cash processing unit 114 for receiving payment from the consumer 112. In one embodiment, the server 102 communicates with a financial account server 102 that is associated with a financial account of the consumer to provide payment for the service by the consumer 112. The server 102 may also communicate with the computing device 108 to receive cash payment via the cash processing unit 114. The financial account may be any type, such as a credit card account, a debit card account, or a PAYPAL™ account. Prior to activation, renewal, or otherwise management of the service, the server 102 facilitates a financial transaction between the service provider computing device 208 and the financial account server 102 associated with the consumer to provide payment for the service. The financial account server 102 has one or more processors and executable instructions stored in volatile and/or non-volatile memory for performing the actions and/or steps described herein.

The data source 106 stores advertising content 120, consumer registration information 122, kiosk demographic information 124, and merchant information 126. The advertising content includes that which may be downloaded to or streamed to the computing devices 108 for play at specified schedules. The consumer registration information 122 includes registration information entered by consumers who consume the advertising content 120. The kiosk demographic information 124 and merchant information 126 are used by the application 104 to calculate probabilities for determining whether each consumer wins or does not win a prize. Although the data source 106 is shown as being located on, at, or within the server 102, it is contemplated that the data source 106 can be located remotely from the local server 102 in other aspects of the system 100, such as on, at, or within a database of a data management system or a database of another computing device or system having at least one processor and volatile and/or non-volatile memory.

The communication network 128 can be the Internet, an intranet, or another wired and/or wireless communication network. In one aspect, one or more of the server 102 and the computing device 108 communicate with one another using any suitable protocol or messaging scheme. For example, the server 102 and computing device 108 may communicate using a Hypertext Transfer Protocol (HTTP), extensible markup language (XML), extensible hypertext markup language (XHTML), or a Wireless Application Protocol (WAP) protocol. Other examples of communication protocols exist. Although the example of FIG. 1A shows the server 102 communicating with the computing device 108 through a network, other embodiments contemplate the server 102 communicating directly with the computing device 108 without the use of a separate and a distinct network. Additionally, other embodiments contemplate that the modules employed by the server 102 and the computing device 108 are integrated in one computing system.

FIG. 1B depicts an example embodiment of a kiosk computing device 108 according to one aspect of the kiosk marketing promotion system 100. The computing device 108 is a computing or processing device that includes one or more processors 140 and memory 142 and is to receive data and/or communications from, and/or transmit data and/or communications to, the server 102 via the communication network 128. The computing device 108 includes a display 144, such as a computer monitor, for displaying data and/or a graphical user interface 146. The computing device 108 may also include an input device 148, such as a keyboard or a pointing device (e.g., a mouse, trackball, pen, or touch screen) to enter data into or interact with the graphical user interface 146. In one embodiment, the display 144 comprises a touchscreen device in which input is provided via contact by the consumer with the touchscreen device.

The computing device 108 may also include a graphical user interface (or GUI) application 150, such as a browser application, or application software (i.e., a mobile app) stored in the memory 142 and executed on the processors 140 to generate a graphical user interface 146 to the display 144. The graphical user interface 146 enables the computing device 108 of the consumer to interact with one or more data entry forms received from the server 102 to enter detail data for the purpose of managing an account of the consumer 112.

In one embodiment, the operating software of the computing device 108 may be configured as a permissions-based format such that only the GUI application 150 is allowed to execute for playing the interactive content. In this manner, consumers may be inhibited from executing any other application on the computing device 108. The GUI application 150 may also include administrator privileges (e.g. super user mode) that can be accessed via a unique key combination (e.g., password access) for servicing, maintaining, or otherwise administering the operation of the computing device 108. For example, the GUI application 150 may, under administration privileges, control what interactive content is played, at what times the interactive content is played, and/or with what frequency the interactive content is played on its respective computing device 108.

In one embodiment, the computing device 108 is a commercial off-the-shelf (COTS) computing device, such as a personal computer, a mobile computer, a tablet computer, a mobile device, and/or other computing device that is configured in or on the housing 102 using one or more mounting mechanisms, such as screws, bolts, hooks, zip ties, adhesives, track system, or other mechanism, such as one that maintains the computing device in or on the housing 102 using a tensioning mechanism. Such as COTS device includes a charging tether for providing power to the computing device, and/or a security or lasso tether to prevent its theft.

In a particular embodiment, the computing device 108 is a tablet computer and the application 104 is embodied as application software (i.e., an app) designed to be executed on the computing device 108. The operating software may be configured as a permissions-based format such that only the app is allowed to execute for administering the kiosk marketing promotion system 100. That is, consumers may be inhibited from executing any other application on the computing device 108. Additionally, the app may be locked (i.e., inhibited from executing) in response to detection of a tampering event and/or due to malfunction of the system. The server 102 may also include administrator privileges (e.g. super user mode) that can be accessed via a unique key combination (e.g., password access) for servicing, maintaining, or otherwise administering the operation of the computing device 108. The tablet computer may be configured on the housing 102 such that its display is oriented in either a landscape mode or a portrait mode.

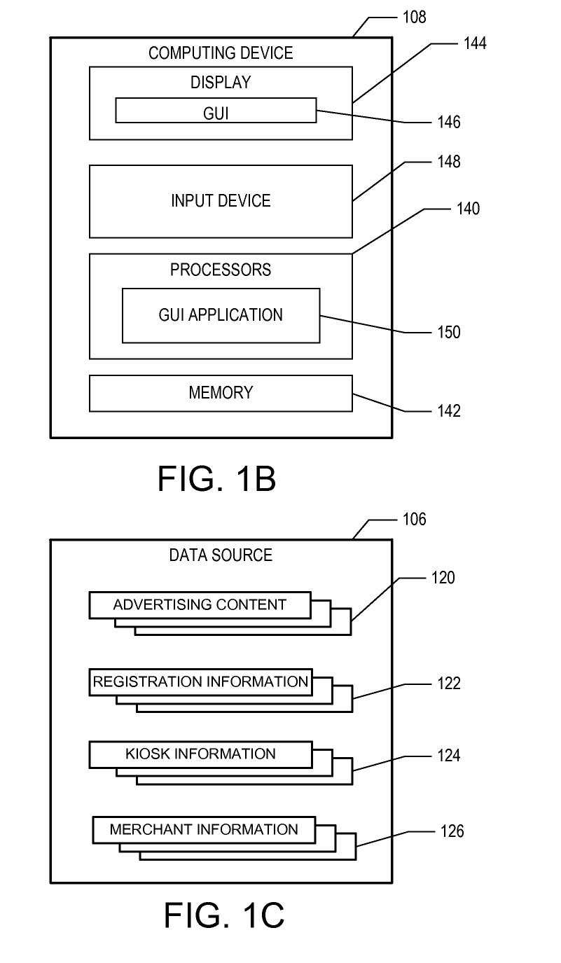

FIG. 2 is a block diagram depicting an example kiosk management application 104 executing on the kiosk management server 102. According to one aspect, the kiosk management server 102 includes a processing system 202 that includes one or more processors or other processing devices. A processor is hardware. The processing system 202 executes the kiosk management application 104 to generate a GUI on a display of the computing device 108 in order to receive account information from a consumer and manage an account associated with one or more consumer items displayed on the kiosk. According to another aspect, the kiosk management server 102 also includes a display 206, such as a computer monitor, for displaying data and/or a graphical user interface 208. The kiosk management server 102 may also include an input device 210, such as a keyboard or a pointing device (e.g., a mouse, trackball, pen, or touch screen) to enter data into or interact with the graphical user interface 222.

According to one aspect, the kiosk management server 102 includes a computer readable media 204 on which the kiosk management application 104 and data source 106 are stored. The kiosk management application 104 includes instructions or modules that are executable by the processing system 202 to perform the features of embodiments of the present disclosure described herein.

The computer readable media 204 may include volatile media, nonvolatile media, removable media, non-removable media, and/or another available media that can be accessed by the kiosk management server 102. By way of example and not limitation, computer readable media 204 comprises computer storage media and communication media. Computer storage media includes non-transient storage memory/media, volatile media, nonvolatile media, removable media, and/or non-removable media implemented in a method or technology for storage of information, such as computer/machine readable/executable instructions, data structures, program modules, and/or other data. Communication media may embody computer readable instructions, data structures, program modules, or other data and include an information delivery media or system.

A GUI interface module 212 facilitates the receipt of data and/or other communications from the computing device 108 of the kiosk 102. In one example, the computing device 108 executes a graphical user interface (GUI) that displays an interactive display, or other suitable user interface mechanism including one or more selectable fields, editing screens, and the like for receiving instructions and data and activating the card by the consumer.

A consumer financial account management module 214 communicates with a payment processing server, such as the financial account server 102, to transact a monetary transfer of funds from the consumer's financial account to a financial account of the merchant of the stored value card, such as the validation server 118. For example, the consumer financial account management module 214 receives credit card information from a card reader and transmits this information to the financial account server 116 associated with the consumer to facilitate payment for the stored value card 114.

A probability calculation module 216 determines a probability to be used for determining whether each consumer wins a prize or not. In one embodiment, calculates the probability on a periodic basis, such as every day or once every week. The probability calculation module 216 may increase or decrease the probability according to certain characteristics, such as an enticement to increase sales, or changes in seasonal patterns with respect to each type of stored value card 114 available for sale. In another embodiment, the probability calculation module 216 calculates the probability according to a group of retail kiosks 110 disposed within a geographical region, such as a county or state where the group of kiosks 110 are located. In this case, the probability calculation module 216 may access the kiosk demographic information 124 stored in the data source 106 such that the probability may be tailored for consumers in that geographical region. In other embodiments, the probability calculation module 216 may calculate the probability according to one or more merchants that sponsor the stored value cards, one or more distributors of the stored value cards. Additionally, the probability calculation module 216 may calculate the probability according to a gamut of all retail kiosks managed by the kiosk marketing promotion system.

In one embodiment, a user having administrative privileges may add, remove, or change how the probability is calculated by accessing the kiosk management application 104 at the kiosk 110 via its GUI 146 or remotely from the kiosk management server 102 via its GUI 208. For example, a user noting that sales of stored value cards have been going down in a particular demographic region, may increase the probability for kiosks 110 in that region to boost sales of the stored value cards. Additionally, the probability may be manipulated for differing time periods, such as one probability to be applied during the morning hours and another probability to be applied in the evening hours.

A remote management module 218 manages the play (i.e., output) of interactive marketing promotion content on the display 144 from a remote location, such as the kiosk management server 102. In one embodiment, the remote management module 218 generates a graphical user interface (GUI) 208 on the kiosk management server 102 that displays various activities and provides for administrative control of one or more computing devices 108 of the kiosks 110. The GUI 208 may also be generated in the form of a dashboard in which multiple characteristics of each of multiple computing devices 108 may be monitored and controlled. The GUI 208 may display various characteristics of each computing device 108, such as sales data, location data obtained via a location detection device (e.g., global positioning system (GPS) device) of the computing device 108, and any operating state information associated with the computing device 108. Additionally, the GUI 208 may receive user input via the input device 210 to control the operation of the computing device 108. For example, an administrator may, from the GUI 208, control the computing device 108 to inhibit or allow certain functionality, perform periodic maintenance on the computing device 108, and/or access one or more log files associated with the operation of the computing device 108.

In one embodiment, an administrator, via the GUI 208, may manage advertising content that is displayed on the computing device 108. That is, a user having administrative privileges on the kiosk computing device 108 may add, remove, or change how the advertising messages are played by accessing the kiosk management application 104 at the kiosk 110 via its GUI 146 or remotely from the kiosk management server 102 via its GUI 208. For example, the administrator may set a first advertising message of a first merchant to be displayed on the computing device 108 at set intervals, such as every 5 minutes, and set a second advertising message of a second merchant to be displayed on the computing device 108 at other set intervals, such as every 15 minutes, based upon any previously made financial agreements between the merchants and the administrator of the kiosk management server 102.

The computing device 108 may store multiple advertising messages in a playlist in which each advertising message is played according to its order in the playlist. In one embodiment, the user may adjust how the advertising messages are played according to a particular time period, such a time of day (e.g., morning, working hours, afternoon, evening, nighttime, etc.), or a season of the year (spring, winter, summer, autumn, Christmas, Easter, etc.). For example, the computing device 108 may be configured to play advertising messages arranged in a first playlist during the morning hours (e.g., 4:00 AM to 8:00 AM), and play the same or other advertising messages arranged in a second playlist during the working hours of the day (e.g., 8:00 AM to 5:00 PM). Additionally, other playlists may be provided for other times of the day (e.g., evening, nighttime, etc.).

The remote management module 218 also communicates with the computing device 108 of the kiosk 100 to manage various aspects of its operation. For example, the remote management module 218 may communicate with the computing device 108 to ensure its proper operation, and disable the computing device 108 from further operation if a failure or malfunction is detected. In one embodiment, the remote management module 218 may erase the memory of the computing device 108 if a tampering event is detected. Also, the remote management module 218 may provide for remote access to the computing device 108 from the kiosk management server 102. The remote management module 218 may also communicate with the computing device 108 to administer software updates to the computing device 108.

In one embodiment, the remote management module 218 may communicate with one or more sensors of the kiosk 100 for surveillance and/or tamper detection purposes. For example, the remote management module 218 may receive images and/or video information from a camera of the kiosk 110 by generating an image of the nearby consumers at periodic intervals (e.g., 5 second intervals). The computing device 108 stores the images for future reference in the event that a tampering event is detected at a later time. Alternatively, the computing device 108 transmits the images to a kiosk management server 102 for storage in the data source 106.

A gift card activation module 220 facilitates the activation of a stored value card won by the consumer. For example, the stored value card activation module 220 may manage the activation of the gift card by communicating with a merchant of the stored value card or a stored value card validation server 118 associated with that merchant to activate its use with that merchant. In one embodiment, the stored value card validation server 118 may include a third party gift card activation service for activation of the stored value card, such as SVS™, STORE FINANCIAL™, and the like.

A physical gift card or a digital gift card (e-gift card) may be activated. In one embodiment, an e-gift card may be generated in digital form and transmitted to the recipient via any suitable communication mechanism, such as via an e-mail message or a short message service (SMS) message. The e-gift card may be printable in a form suitable for redemption at a retail outlet of a merchant associated with the e-gift card.

It should be appreciated that the modules described herein are provided only as an example of a computing device that may execute the kiosk management application 104 according to the teachings of the present invention, and that other computing devices may have the same modules, different modules, additional modules, or fewer modules than those described herein. For example, one or more modules as described in FIG. 2 may be combined into a single module. As another example, certain modules described herein may be encoded and executed on other computing devices, such as the computing device 108 used by the consumer. Further, one or more or all of the modules may be stored and executed by the kiosk management server 102 and data and instructions are transmitted to and from the kiosk management server 102 and the computing device 108 to execute their functions.

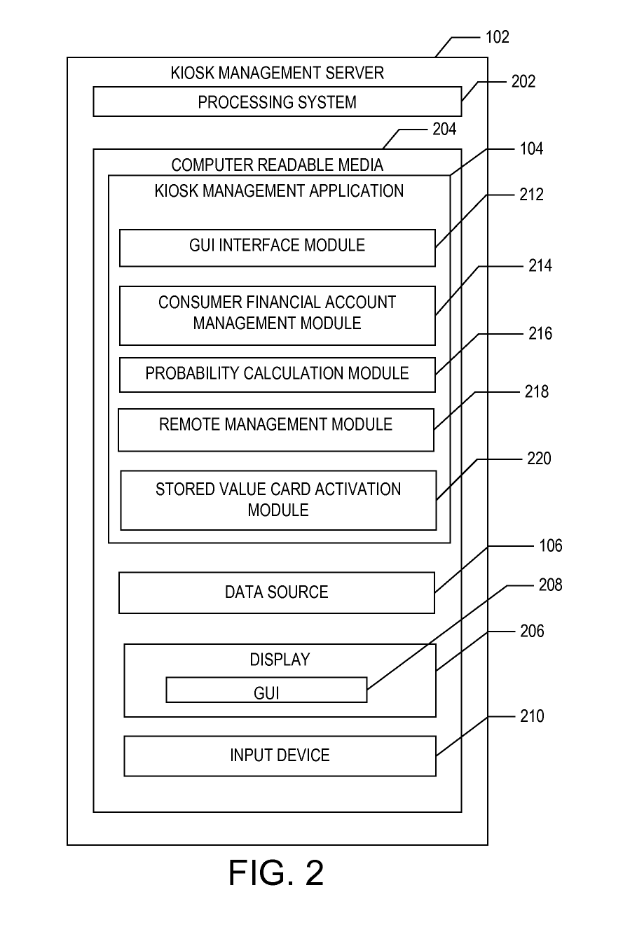

FIG. 3 illustrates an example process that may be performed by the kiosk marketing promotion system 100 according to the teachings of the present disclosure.

In step 302, the kiosk management application 104 transmits interactive advertising content 120 stored in the data source 106 to the computing devices 108 of the retail kiosks 110. The interactive advertising content 120 may be downloaded at regular intervals such that the computing device 108 of the kiosk 110 calculates the probability, and determines whether each consumer wins or loses, or the interactive content 120 may be streamed to the computing device 108 such that the application 104 calculates the probability and determines whether each consumer wins or loses.

In one embodiment, the application 104 may transmit a first instance of interactive advertising content to a first set of kiosks, while transmitting a second instance of interactive advertising content to a second set of kiosks. This may be performed to increase incentives based upon demographic variations. For example, a group of kiosks 110 located near a popular fishing lake may receive a certain instance of interactive advertising content that is weighted towards stored value cards associated with fishing supplies, while another group of kiosks 110 located near a tourist region may receive an instance of interactive advertising content that is weighted towards stored value cards associated with tourist items, such as suntan lotion.

The sequence, duration, and/or scheduling of interactive content may be modified through the use of the GUI 208 of the server 102 and/or through the use of the GUI application 150 of the computing device 108. For example, an administrator of the kiosk management server 102 may manage what interactive content is played on each computing device 108 as well as how often each instance of interactive content is played. Additionally, a user, such as a proprietor where the kiosk 110 is disposed, may modify the interactive content that is played during an administrative session using the GUI application 150.

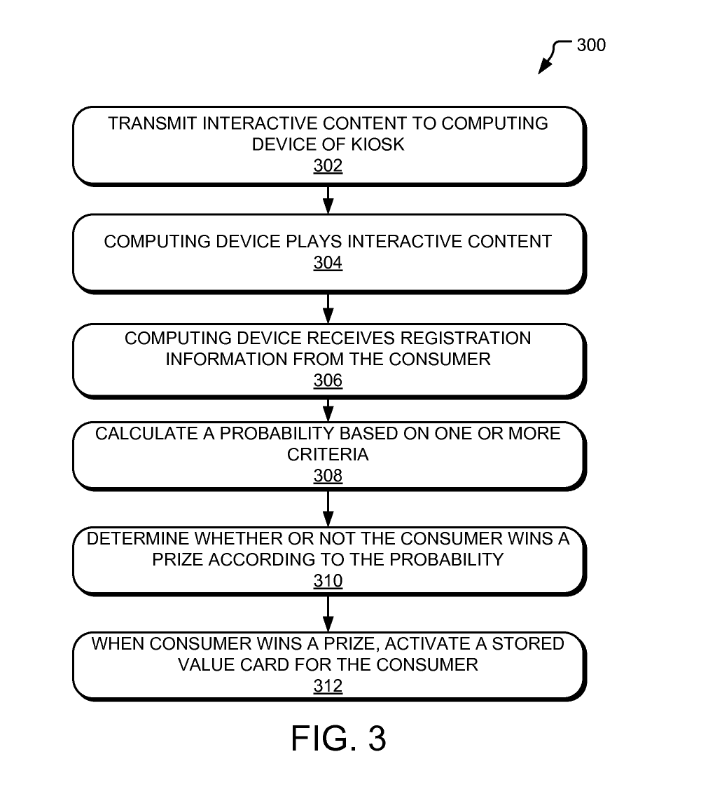

In step 304, the computing device 108 plays the received interactive advertising content 120 on its display. For example, the computing device 108 may display a splash screen (FIG. 4) indicating that an opportunity exists for the consumer 112 to win a prize, such as a specified amount of money. In one embodiment, the content also displays recent winners along with their location to enhance enticement for involving the consumer by the system. In another embodiment, the content also displays a total amount to be given away and how much money is left to be given in the future.

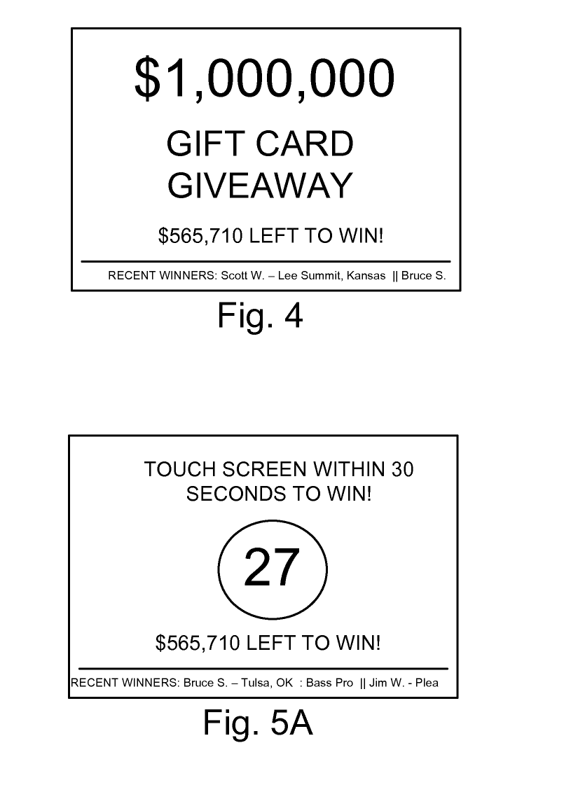

In one embodiment, the computing device 108 displays a countdown timer screen (FIG. 5B) that displays a countdown timer to further entice a consumer's involvement with the system 100. For example, the countdown timer screen displays a total amount of time associated with the timer and the current amount of time left for the consumer. The countdown timer screen may include other visual or audible enticements for the consumer. For example, the countdown timer screen (FIG. 5B) may display a rolling wheel that displays an image of potential stored value cards that may be won by the consumer. The countdown timer screen may also generate a ticking sound via a speaker or other sound generating device of the computing device to coincide with each advance of the countdown timer. As another example, the computing device 108 may generate a human-like voice that speaks the remaining time left on the countdown timer.

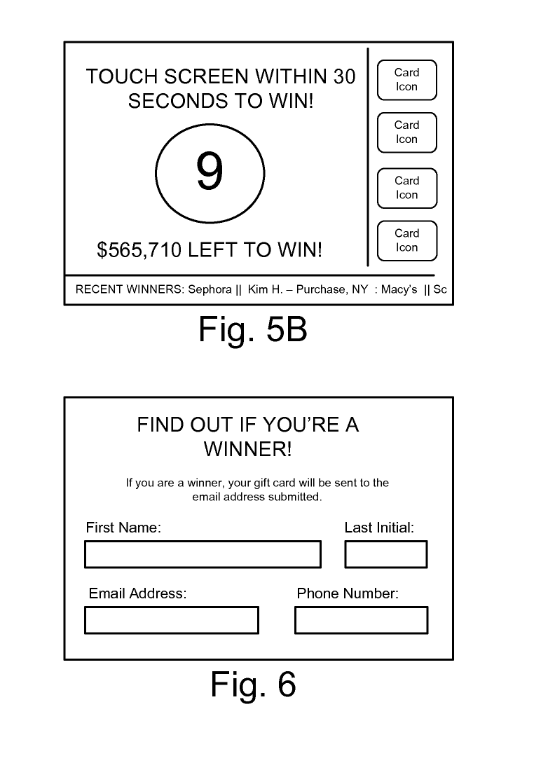

In step 306, the computing device 108 receives personal information from the consumer 112 and stores the consumer information in the data source 106. For example, the consumer 112 may respond to the splash screen (FIG. 4) or countdown timer screens (FIGS. 5A and 5B) by touching the screen of the computing device 108, or utilizing some other suitable input device (e.g., microphone) of the computing device 108. If the consumer 112 responds in such a manner, the computing device 108 may then display a consumer registration screen (FIG. 6) that includes various fields for entry of personal information associated with the consumer. As shown, the fields include a first name field, a last initial field, an e-mail address field, and a phone number field. Nevertheless, it should be understood that any type of field may be used, such as an address field for entry of the consumer's physical address, or an age field for entry of the consumer's age.

In step 308, the computing device 108 calculates a probability to be used by the computing device 108 of each retail kiosk 110. For example, the computing device 108 and/or kiosk management application 104 may calculate a probability based on one or more retail stores in a specified geographical region, one or more merchants that sponsor the stored value cards, one or more distributors of the stored value cards, or even all of the retail kiosks managed by the kiosk marketing promotion system.

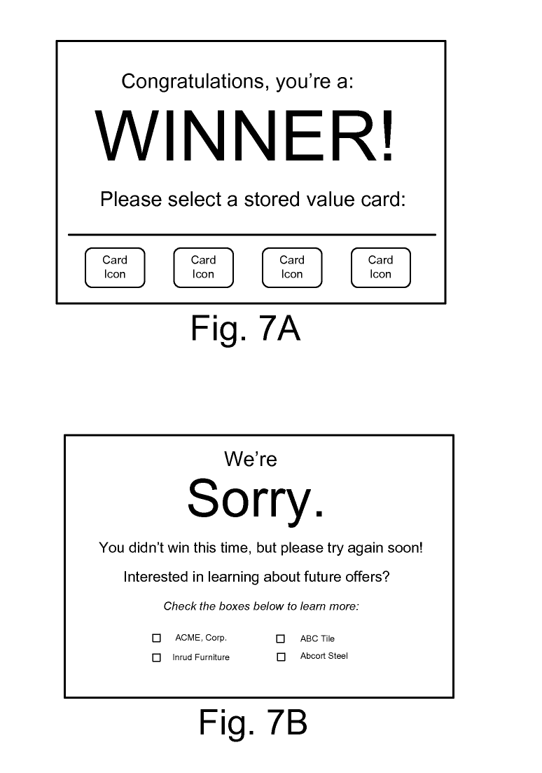

In step 310, the computing device 108 determines whether the consumer wins the prize or not according to the calculated probability and displays the result for the consumer. For example, the computing device 108 may display a winner screen (FIG. 7A) in the event that the consumer has won, or a loser screen (FIG. 7B) in the event that the consumer did not win the prize. In one embodiment, the loser screen may include information about certain future offers, such as specialized financial incentives to promote further sales of the stored value cards. For example, the loser screen may include information associated with certain merchants that may offer discounts for certain products that they sell or even monetary discounts for their stored value cards. In this case, the consumer 112 may select a desired merchant such that the computing device 108 may display other information (not shown) related to promotional offers provided by that merchant.

In step 312, the computing device 108 activates the stored value card, that has been won by the consumer. In one embodiment, the computing device 108 may provide for selection, by the consumer, of a stored value card from among multiple stored value cards. For example, the winner screen (FIG. 7A) may display several icons representing stored value cards (e.g., gift cards) such that, when one icon is selected by the winning consumer, the computing device 108 activates that stored value card for the consumer.

The computing device 108 may activate a physical stored value card located at the kiosk 110, or it may activate an electronic stored value card that is then transmitted to the winning consumer using a suitable transport medium, such as via e-mail or an SMS message.

The system 100 as described above may be repeated for other consumers to enhance involvement in the stored value cards 114 sold by the retail kiosk 110. Nevertheless, when use of the kiosk marketing promotion system is no longer needed or desired, the process ends.

It should be appreciated that the steps described herein are provided only as an example of a process that is performed by the kiosk management application 104 according to the teachings of the present invention, and that the kiosk management application 104 may perform fewer, more, or different types of steps than those described herein. For example, the kiosk management application 104 performs multiple steps described above as a single step, or perform a single step as multiple, distributed steps. As another example, the system 100 may also facilitate a transaction for one or more stored value cards 114 displayed by the retail kiosk 110 with or without use of the interactive content. In another embodiment, the kiosk marketing promotion system 100 may be used for display of advertising information or other types of information to the consumer associated with the stored value cards independent of the interactive content. That is, the kiosk marketing promotion system 100 may display information, including interactive information, to the consumer without attempting to win any prize or conducting a transaction for a stored value card.

For a particular embodiment in which the computing device 108 is a tablet computer, a specified executable application (i.e., an app) may be used to generate the GUI from which information is received from the consumer. The operating software may be configured as a permissions-based format such that the consumer is only allowed to execute the app for administering the kiosk marketing promotion system 100. That is, the consumer is inhibited from executing any other application on the computing device 108.

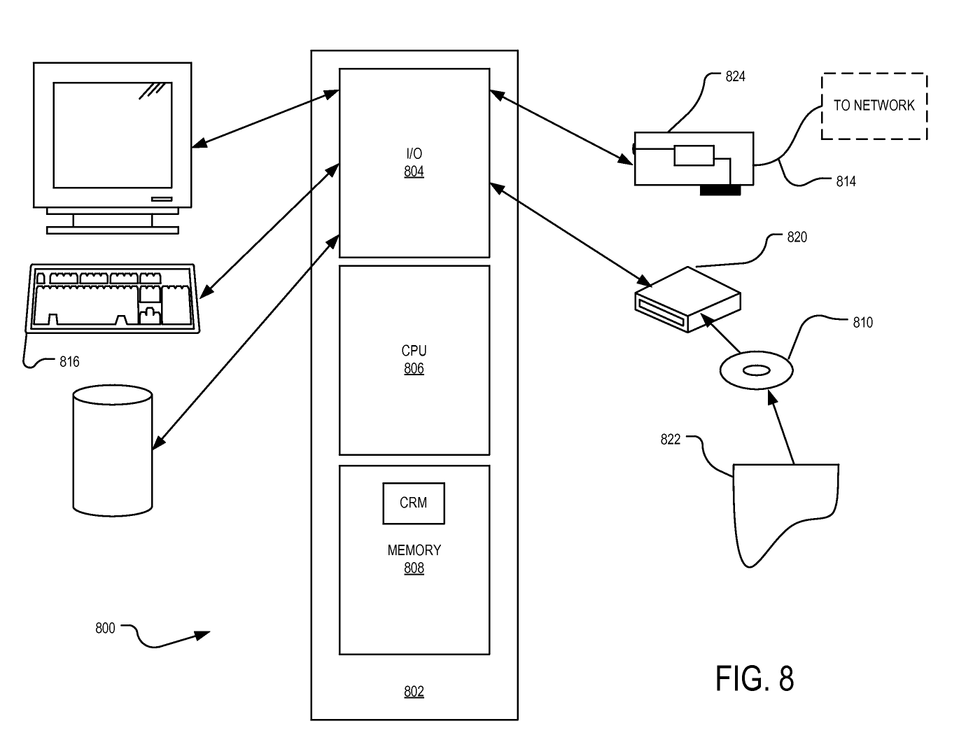

FIG. 8 illustrates an example computing system 800 that may implement various systems, such as the control circuit 118, and methods discussed herein, such as process 300. A general purpose computer system 800 is capable of executing a computer program product to execute a computer process. Data and program files may be input to the computer system 800, which reads the files and executes the programs therein such as the application 104. Some of the elements of a general purpose computer system 800 are shown in FIG. 8 wherein a processor 802 is shown having an input/output (I/O) section 804, a central processing unit (CPU) 806, and a memory section 808. There may be one or more processors 802, such that the processor 802 of the computer system 800 comprises a single central-processing unit 806, or a plurality of processing units, commonly referred to as a parallel processing environment. The computer system 800 may be a conventional computer, a server, a distributed computer, or any other type of computer, such as one or more external computers made available via a cloud computing architecture. The presently described technology is optionally implemented in software devices loaded in memory 808, stored on a configured DVD/CD-ROM 810 or storage unit 812, and/or communicated via a wired or wireless network link 814, thereby transforming the computer system 800 in FIG. 8 to a special purpose machine for implementing the described operations.

The memory section 808 may be volatile media, nonvolatile media, removable media, non-removable media, and/or other media or mediums that can be accessed by a general purpose or special purpose computing device. For example, the memory section 808 may include non-transitory computer storage media and communication media. Non-transitory computer storage media further may include volatile, nonvolatile, removable, and/or non-removable media implemented in a method or technology for the storage (and retrieval) of information, such as computer/machine-readable/executable instructions, data and data structures, engines, program modules, and/or other data. Communication media may, for example, embody computer/machine-readable/executable, data structures, program modules, algorithms, and/or other data. The communication media may also include an information delivery technology. The communication media may include wired and/or wireless connections and technologies and be used to transmit and/or receive wired and/or wireless communications.

The I/O section 804 is connected to one or more user-interface devices (e.g., a keyboard 816 and a display unit 818), a disc storage unit 812, and a disc drive unit 820. Generally, the disc drive unit 820 is a DVD/CD-ROM drive unit capable of reading the DVD/CD-ROM medium 810, which typically contains programs and data 822. Computer program products containing mechanisms to effectuate the systems and methods in accordance with the presently described technology may reside in the memory section 808, on a disc storage unit 812, on the DVD/CD-ROM medium 810 of the computer system 800, or on external storage devices made available via a cloud computing architecture with such computer program products, including one or more database management products, web server products, application server products, and/or other additional software components. Alternatively, a disc drive unit 820 may be replaced or supplemented by a floppy drive unit, a tape drive unit, or other storage medium drive unit. The network adapter 824 is capable of connecting the computer system 800 to a network via the network link 814, through which the computer system can receive instructions and data. Examples of such systems include personal computers, Intel or PowerPC-based computing systems, AMD-based computing systems, ARM-based computing systems, and other systems running a Windows-based, a UNIX-based, a mobile operating system, or other operating system. It should be understood that computing systems may also embody devices such as Personal Digital Assistants (PDAs), mobile phones, tablets or slates, multimedia consoles, gaming consoles, set top boxes, etc.

When used in a LAN-networking environment, the computer system 800 is connected (by wired connection and/or wirelessly) to a local network through the network interface or adapter 824, which is one type of communications device. When used in a WAN-networking environment, the computer system 800 typically includes a modem, a network adapter, or any other type of communications device for establishing communications over the wide area network. In a networked environment, program modules depicted relative to the computer system 800 or portions thereof, may be stored in a remote memory storage device. It is appreciated that the network connections shown are examples of communications devices for and other means of establishing a communications link between the computers may be used.

In an example implementation, source code executed by the control circuit 118, a plurality of internal and external databases are stored in memory of the control circuit 118 or other storage systems, such as the disk storage unit 812 or the DVD/CD-ROM medium 810, and/or other external storage devices made available and accessible via a network architecture. The source code executed by the control circuit 118 may be embodied by instructions stored on such storage systems and executed by the processor 802.

Some or all of the operations described herein may be performed by the processor 802, which is hardware. Further, local computing systems, remote data sources and/or services, and other associated logic represent firmware, hardware, and/or software configured to control operations the system 100 and/or other components. Such services may be implemented using a general purpose computer and specialized software (such as a server executing service software), a special purpose computing system and specialized software (such as a mobile device or network appliance executing service software), or other computing configurations. In addition, one or more functionalities disclosed herein may be generated by the processor 802 and a user may interact with a Graphical User Interface (GUI) using one or more user-interface devices (e.g., the keyboard 816, the display unit 818, and the user devices 804) with some of the data in use directly coming from online sources and data stores. The system set forth in FIG. 8 is but one possible example of a computer system that may employ or be configured in accordance with aspects of the present disclosure.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon executable instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may include, but is not limited to, magnetic storage medium (e.g., floppy diskette), optical storage medium (e.g., CD-ROM); magneto-optical storage medium, read only memory (ROM); random access memory (RAM); erasable programmable memory (e.g., EPROM and EEPROM); flash memory; or other types of medium suitable for storing electronic executable instructions.

The description above includes example systems, methods, techniques, instruction sequences, and/or computer program products that embody techniques of the present disclosure. However, it is understood that the described disclosure may be practiced without these specific details.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A kiosk marketing promotion system comprising:
a retail kiosk to hold and display one or more stored value cards; and
a kiosk computing device to be housed and supported by the retail kiosk and having a display screen for generating a graphical user interface (GUI) that plays interactive marketing promotion content on the display screen to:
play advertising content associated with the stored value cards displayed by the retail kiosk;
receive, from the consumer, personal information associated with the consumer; and
when the personal information is received, determine whether the consumer wins a prize according to a specified probability, the prize comprising at least one of the stored value cards displayed by the retail kiosk.

2. The kiosk marketing promotion system of claim 1, wherein the computing device calculates the specified probability on a periodic basis.

3. The kiosk marketing promotion system of claim 1, wherein the computing device calculates the specified probability according to at least one of one or more retail stores in a specified geographical region, one or more merchants that sponsor the stored value cards, one or more distributors of the stored value cards, and a gamut of all of a plurality of retail kiosks managed by a server of the kiosk marketing promotion system.

4. The kiosk marketing promotion system of claim 1, wherein the advertising content comprises a countdown timer that displays a remaining amount of time that the consumer is allowed to interact with the computing device.

5. The kiosk marketing promotion system of claim 1, wherein when the consumer does not win the prize, the computing device displays one or more special financial incentives to purchase the stored value cards.

6. The kiosk marketing promotion system of claim 1, wherein the computing device displays information associated with previous winners, the information comprising at least one of a name of each winner and the geographical location of each winner.

7. The kiosk marketing promotion system of claim 1, wherein the computing device activates a stored value card for the consumer when the consumer has won the prize.

8. The kiosk marketing promotion system of claim 7, wherein the computing device receives user input for selecting one stored value cards from among the stored value cards displayed by the kiosk.

9. The kiosk marketing promotion system of claim 7, wherein the computing device transmits a message including an electronic stored value card to the consumer that won the prize.

10. The kiosk marketing promotion system of claim 1, wherein the computing device receive user input for changing the interactive marketing promotion content that is played on the computing device, the user input received via at least one of the GUI of the computing device or a GUI of a server that manages the operation of the computing device.

11. A kiosk marketing promotion method comprising:
playing, using instructions stored in at least one memory and executed by at least one processor, advertising content associated with the stored value cards displayed on the retail kiosk by a kiosk computing device that is housed and supported by a retail kiosk, the computing device having a display screen for generating a graphical user interface (GUI) that plays interactive marketing promotion content on the display screen;
receive, using the instructions, personal information associated with the consumer from the consumer; and
when the personal information is received, determining, using the instructions, whether the consumer wins a prize according to a specified probability, the prize comprising at least one of the stored value cards displayed by the retail kiosk.

12. The kiosk marketing promotion method of claim 11, further comprising calculating the specified probability according to at least one of one or more retail stores in a specified geographical region, one or more merchants that sponsor the stored value cards, one or more distributors of the stored value cards, and a gamut of all of a plurality of retail kiosks managed by a server of the kiosk marketing promotion system.

13. The kiosk marketing promotion method of claim 11, further comprising displaying a countdown timer that displays a remaining amount of time that the consumer is allowed to interact with the computing device.

14. The kiosk marketing promotion method of claim 11, further comprising when the consumer does not win the prize, displaying one or more special financial incentives to purchase the stored value cards.

15. The kiosk marketing promotion method of claim 11, further comprising displaying information associated with previous winners, the information comprising at least one of a name of each winner and the geographical location of each winner.

16. The kiosk marketing promotion method of claim 11, further comprising activating a stored value card for the consumer when the consumer has won the prize.

17. The kiosk marketing promotion method of claim 16, further comprising receiving user input for selecting one stored value cards from among the stored value cards displayed by the kiosk.

18. The kiosk marketing promotion method of claim 16, further comprising transmitting a message including an electronic stored value card to the consumer that won the prize.

19. The kiosk marketing promotion method of claim 11, further comprising receiving user input for changing the interactive marketing promotion content that is played on the computing device, the user input received via at least one of the GUI of the computing device or a GUI of a server that manages the operation of the computing device.

20. A kiosk marketing promotion system comprising:
a kiosk management server in communication with one or more kiosk computing devices, each kiosk computing device configured to be housed and supported by a retail kiosk and having a display screen for generating a graphical user interface (GUI) that plays interactive marketing promotion content on the display screen, the kiosk management server configured to:
download advertising content associated with the stored value cards displayed by each retail kiosk to its respective kiosk computing device, the kiosk computing device playing the advertising content according to a specified schedule;
receive, from the kiosk computing device, personal information associated with the consumer;
when the personal information is received, determine whether the consumer wins a prize according to a specified probability, the prize comprising at least one of the stored value cards displayed by the retail kiosk; and
transmit a message to the kiosk computing device indicating whether or not the consumer has won the prize.

21. The kiosk marketing promotion system of claim 20, wherein the kiosk management server calculates the specified probability according to at least one of one or more retail stores in a specified geographical region, one or more merchants that sponsor the stored value cards, one or more distributors of the stored value cards, and a gamut of all of a plurality of retail kiosks managed by a server of the kiosk marketing promotion system.

22. The kiosk marketing promotion system of claim 20, wherein when the consumer does not win the prize, the kiosk management server displays one or more special financial incentives to purchase the stored value cards.

23. The kiosk marketing promotion system of claim 20, wherein the kiosk management server activates a stored value card for the consumer when the consumer has won the prize.

24. The kiosk marketing promotion system of claim 23, wherein the kiosk management server receives user input for selecting one stored value cards from among the stored value cards displayed by the kiosk.
